(19) United States
(12) Patent Application Publication
(10) Pub. No.: US 2002/0069149 A1
(43) Pub. Date: Jun. 6, 2002

(54) Performance participation and revenue sharing in an investment management affinity program

(75) Inventors: Mark L. Maxwell, Mississauga (CA); Jonathan M. Wellum, Mississauga (CA)

Correspondence Address: MARK KUSNER COMPANY LPA, HIGHLAND PLACE SUITE 310, 6151 WILSON MILLS ROAD, HIGHLAND HEIGHTS, OH, 44143

(73) Assignee: Max Wellum Management Inc.

(21) Appl. No.: 10/005,008

(22) Filed: Dec. 4, 2001

Related U.S. Application Data
(60) Provisional application No. 60/251,460, filed on Dec. 5, 2000.

(51) Int. Cl. G06F 17/60

(52) U.S. Cl. 705/36

(57) ABSTRACT

A data processing system for managing an affinity program for providing financial support payments to a designated beneficiary. The financial support payments are derived from a mutual fund unit holder's investment management activity. The data processing system includes computer processors and electronic storage that store and retrieve affinity program data for a number of mutual fund unit holders. The affinity program data for each holder includes: number of mutual fund units held; current value of each mutual fund unit held; any mutual fund management fee portion dedicated to the beneficiary by the holder; and any mutual fund financial performance portion dedicated to the beneficiary by the holder. The data processing system calculates any finacial support payment in favour of the beneficiary, as selected by the donor/unit holder from two options: (1) the product of multiplying the mutual fund management fee portion dedicated to the beneficiary by the holder by any mutual fund management fee paid by the mutual fund holder; and (2) the product of multiplying the mutual fund financial performance portion dedicated to the beneficiary by the holder by any financial performance paid to the mutual fund holder.

### TECHNICAL FIELD

The invention is an affinity program to provide continuous or regular financial support to a designated beneficiary or participating organisation, such as for example, a charitable institution, school or university, the support being derived from the donor's investment management activity in the form of a portion of the performance of the investments or a rebate of the usual investment management fee in favour of the beneficiary.

### BACKGROUND OF THE ART

The solicitation of funds for charities, schools, and universities often involves direct contact during social functions, a direct mail campaign, telephone “cold calls” and other well known methods of contacting and persuading potential or established contributors to donate funds.

The number of such contacts, especially directed at wealthy contributors, has reached the point where appeals for funds are perceived unfavourably since the potential contributor is constantly pestered, interrupted and inconvenienced. The need to solicit funds during periodic campaigns is expensive and somewhat unproductive for the charity as well. Minimizing costs involved in generating funds is a primary concern and the ideal form of obtaining funds is one in which a continuous flow of funds is derived rather than intermittent and unreliable funds are generated. Charities must also rely on the labour of volunteers to conduct campaigns for donations by telephoning donors or carrying out other soliciting activities. Volunteers may become disenchanted over time and donors may be overwhelmed by the large number of urgent calls for their help.

To address the fund solicitation problem, many charities have established “affinity” programs with credit card companies and vendors of various products and services wherein a portion of revenues collected are shared with the charity.

For example, a credit card company may establish an affinity program with a university whereby each transaction made by the cardholder generates revenue for the credit card company (ex: 4% of purchase price) and a portion (ex: 0.25% of purchase price) is donated to the university on behalf of the cardholder/donor. Various products and services are also associated with affinity programs either temporarily or permanently. For example, a charity may cooperate with a restaurant chain whereby a portion of revenue for a given period of time is shared with the charity. Other established programs involve sale of products or services whereby a portion of revenue or profit that is generated is thereafter contributed to a participating charity.

Such affinity programs are common in credit card commerce and the participating university may encourage alumni to change their credit card company in order to contribute to the university on a regular basis in this manner. The credit card company obtains the benefit of increased market share whereas the charity secures a more reliable constant flow of contributions.

However, many potential contributors are not involved in such established affinity programs for various reasons. Switching between credit card companies may be undesirable due to the complication of record keeping or loss of existing benefits, air miles or travel credits for example. In addition, contributors may fail to purchase the sponsored products and services due to lack of interest, absence from the country during vacation or retirement, or many other valid reasons unrelated to their commitment to support an organization.

As a result of retirement savings or significant accumulated wealth, many potential contributors have purchased mutual funds or otherwise have made arrangements for a professional financial advisor or manager to manage their funds. Large pools of wealth are managed but to date the revenues generated by such financial activity has not been tapped as a source of regular charitable contributions.

An object of the present invention is to establish an affinity program whereby financial activity related to investment management will result in regular contributions to a participating charity, school or university on behalf of the investor.

A further object of the invention is to generate regular donations to the beneficiary (charity, school or university) and income tax receipts to the donor (investor) automatically without the need for periodic solicitation or intrusive donation campaigns.

Further objects of the invention will be apparent from review of the accompanying drawing and description of the invention below.

### DISCLOSURE OF THE INVENTION

The invention is an affinity program to provide continuous or regular financial support to a designated beneficiary or participating organisation, such as for example, a charitable institution, school or university. The support is derived from the donor's investment management activity in the form of a portion of the performance of the investments or a rebate of the usual investment management fee in favour of the beneficiary.

The financial support payments are derived from a mutual fund unit holder's investment management activity as follows. The data processing system includes computer processors and electronic storage that store and retrieve affinity program data for a number of mutual fund unit holders. The affinity program data for each holder includes: number of mutual fund units held; current value of each mutual fund unit held; any mutual fund management fee portion dedicated to the beneficiary by the holder; and any mutual fund financial performance portion dedicated to the beneficiary by the holder. The data processing system calculates any finacial support payment in favour of the beneficiary, as selected by the donor/unit holder from two options: (1) the product of multiplying the mutual fund management fee portion dedicated to the beneficiary by the holder by any mutual fund management fee paid by the mutual fund holder; and (2) the product of multiplying the mutual fund financial performance portion dedicated to the beneficiary by the holder by any financial performance paid to the mutual fund holder.

Further details of the invention and its advantages will be apparent from the detailed description and drawing included below.

### BRIEF DESCRIPTION OF THE DRAWINGS

In order that the invention may be readily understood, two preferred embodiments of the invention will be described by way of example, with reference to the accompanying drawing wherein:

FIG. 1 is a schematic diagram showing the contractual relationship between fund management (trustee and fund manager), investors (unit holders) and the beneficiary (charity, school, university), and the flow of funds donated to the beneficiary by two optional routes.

### DETAILED DESCRIPTION OF PREFERRED EMBODIMENTS

The invention relates to a program of providing regular contributions or donations to a beneficiary from a participating investor.

In broad aspect the invention is an affinity program whereby a fund manager under a management contract manages the investments of the investor. Common forms of contract include, for example: a mutual fund; pooled fund; investment club; private arrangements under a trust agreement; or execution of a will. All such arrangements have the necessary common features for application of the invention and it is not the intention of the inventors to limit the application of the invention to any particular type of investment vehicle.

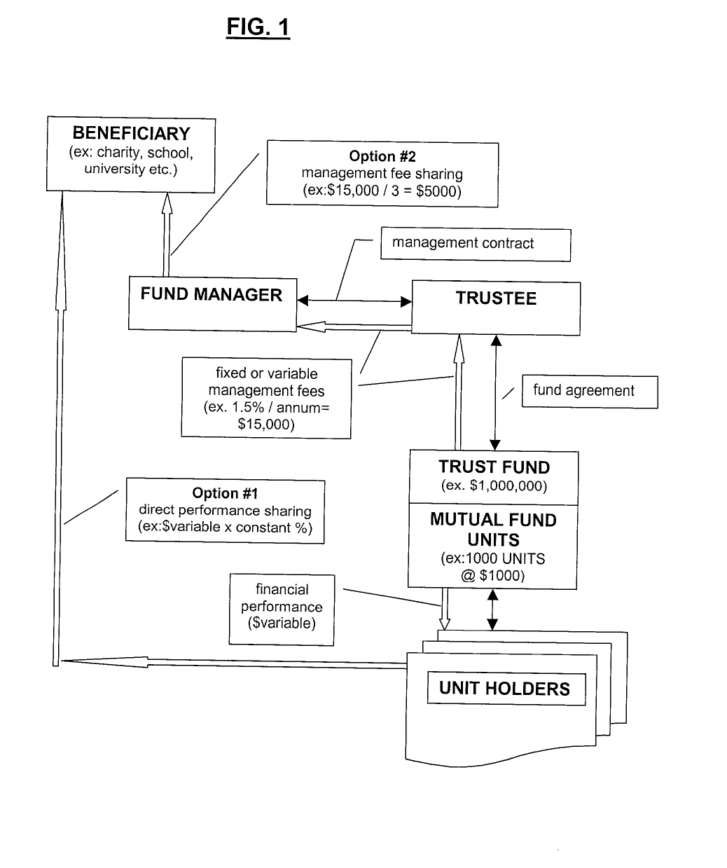

FIG. 1 uses the example of a mutual fund since this is a common well known investment vehicle. A trustee establishes a trust fund to hold the pooled financial resources of mutual fund unit holders. For example, a fund of $1,000,000 may be divided into 1000 units of $1,000 each. Units are bought and sold by various unit holders who subscribe for units with the trustee. The trustee retains a fund manager to invest the funds under the terms of a management contract. Normally the management contract specifies the remuneration of the fund manager. Common forms of payment include a fixed management fee per annum but other forms of incentive programs are also common. For simplicity the example herein will assume a fixed management fee of 1.5% namely $15,000 per year (i.e. $1,000,000 ×1.5%). The investments hopefully generate an income for the unit holder and the financial performance of the investment pool will vary considerably from year to year.

The invention is applied to an established mutual fund arrangement as follows. Investors, who are friends or supporters of a beneficiary organisation, invest a portion of their assets in investment products managed by the mutual fund manager, trustee or other investment management company. The investment may be made directly or through a financial advisor.

The mutual fund manager charges the investor a management fee for money management services. The management fee is usually calculated and accrued daily and is paid at the end of each month, however, other arrangements can be negotiated. Over time the value of the investment units increases and the unit holder/investor realises a return on their investment either in the form of cash added to their account or in additional units.

In a first embodiment of the invention (Option #1) the investor elects to donate a constant percentage of the financial performance or return on investment to the beneficiary. The regularly payable management fee is applied. If the percentage of contribution is 10% for example, 90% of the financial performance is retained by the investor and 10% is automatically donated to the beneficiary by the fund manager on behalf of the investor. The beneficiary then issues the appropriate income tax receipts to the investor directly.

In a second embodiment of the invention (Option #2) the investor retains 100% of the financial performance but the fund manager donates a portion of the management fee to the beneficiary. The beneficiary also issues income tax receipts to the manager directly, if appropriate. For example, where the fund manager charges a management fee of 1.5% to generate revenue of $15,000 from a $1,000,000 investment fund, the program includes a rebate of management fees paid to the beneficiary by the fund manager. For example, in an agreement between the fund manager and the beneficiary, the rebate offered may be 33.3% of management fees, which would result in 1.0% ($10,000) retained by the fund manager and 0.5% ($5,000) donated to the beneficiary.

Since the financial performance may vary, option #1 would result in a less predictable flow of donations whereas option #2 would be more constant, depending on the asset load of the mutual fund. On the other hand, if investments are less profitable, the investor is not required to contribute a fixed amount but rather contributes a portion of profits when option #1 is elected. Of course a combination of these options is also possible, the key concepts being revenue share (between the beneficiary and investment fund manager) and a financial performance share (between the beneficiary and investor).

Although the above description relates to a specific preferred embodiment as presently contemplated by the inventors, it will be understood that the invention in its broad aspect includes functional equivalents of the elements described.

We claim:

1. A data processing system for managing an affinity program for providing financial support payments to a designated beneficiary, said financial support payments being derived from a mutual fund unit holder's investment management activity, the system comprising:
computer processing means for processing data;
electronic storage means, in communication with the processing means, for storing and retrieving affinity program data for a plurality of mutual fund unit holders, the affinity program data for each holder including: number of mutual fund units held; current value of each mutual fund unit held; any mutual fund management fee portion dedicated to the beneficiary by the holder; and any mutual fund financial performance portion dedicated to the beneficiary by the holder; and
calculating means, in communication with the processing means, for calculating any finacial support payment in favour of the beneficiary, said payment selected from the group consisting of: the product of multiplying the mutual fund management fee portion dedicated to the beneficiary by the holder by any mutual fund management fee paid by the mutual fund holder; and the product of multiplying the mutual fund financial performance portion dedicated to the beneficiary by the holder by any financial performance paid to the mutual fund holder.

2. A data processing system according to claim 1 wherein the mutual fund financial performance portion dedicated to the beneficiary by the holder is a fixed percentage of the holder's financial performance.

3. A data processing system according to claim 1 wherein the mutual fund financial performance portion dedicated to the beneficiary by the holder is a fixed amount deducted from the holder's financial performance when financial performance exceeds a predetermined minimum amount.

4. A data processing system according to claim 1 wherein the mutual fund management fee portion dedicated to the beneficiary by the holder is a fixed percentage of the management fee paid by the mutual fund unit holder.
